(19) United States
(12) Patent Application Publication
(10) Pub. No.: US 2017/0374364 A1
(43) Pub. Date: Dec. 28, 2017

(54) Method and Apparatus of Face Independent Coding Structure for VR Video

(71) Applicant: MEDIATEK INC., Hsin-Chu (TW)

(72) Inventors: Jian-Liang LIN, Yilan County (TW); Chao-Chih HUANG, Zhubei City (TW); Hung-Chih LIN, Nantou County (TW); Chia-Ying LI, Taipei City (TW); Shen-Kai CHANG, Zhubei City (TW)

(21) Appl. No.: 15/628,826

(22) Filed: Jun. 21, 2017

Related U.S. Application Data
(60) Provisional application No. 62/353,584, filed on Jun. 23, 2016.

(51) Int. Cl. H04N 19/119; H04N 19/51; H04N 19/61; H04N 19/85

(52) U.S. Cl. CPC H04N 19/119; H04N 19/85; H04N 19/51; H04N 19/61

(57) ABSTRACT

A method and apparatus of video encoding or decoding for a video encoding or decoding system applied to multi-face sequences corresponding to a 360-degree virtual reality sequence are disclosed. According to embodiments of the present invention, at least one face sequence of the multi-face sequences is encoded or decoded using face-independent coding, where the face-independent coding encodes or decodes a target face sequence using prediction reference data derived from previous coded data of the target face sequence only. Furthermore, one or more syntax elements can be signaled in a video bitstream at an encoder side or parsed from the video bitstream at a decoder side, where the syntax elements indicate first information associated with a total number of faces in the multi-face sequences, second information associated with a face index for each face-independent coded face sequence, or both the first information and the second information.

### CROSS REFERENCE TO RELATED APPLICATIONS

The present invention claims priority to U.S. Provisional Patent Application, Ser. No. 62/353,584, filed on Jun. 23, 2016. The U.S. Provisional patent application is hereby incorporated by reference in its entirety.

### FIELD OF THE INVENTION

The present invention relates to image and video coding. In particular, the present invention relates to coding face sequences, where the faces correspond to cube faces or other multiple faces as a representation of 360-degree virtual reality video.

### BACKGROUND AND RELATED ART

The 360-degree video, also known as immersive video is an emerging technology, which can provide “feeling as sensation of present”. The sense of immersion is achieved by surrounding a user with wrap-around scene covering a panoramic view, in particular, 360-degree field of view. The “feeling as sensation of present” can be further improved by stereographic rendering. Accordingly, the panoramic video is being widely used in Virtual Reality (VR) applications.

Immersive video involves the capturing a scene using multiple cameras to cover a panoramic view, such as 360-degree field of view. The immersive camera usually uses a set of cameras, arranged to capture 360-degree field of view. Typically, two or more cameras are used for the immersive camera. All videos must be taken simultaneously and separate fragments (also called separate perspectives) of the scene are recorded. Furthermore, the set of cameras are often arranged to capture views horizontally, while other arrangements of the cameras are possible.

The 360-degree panorama camera captures scenes all around and the stitched spherical image is one way to represent the VR video, which continuous in the horizontal direction. In other words, the contents of the spherical image at the left end continue to the right end. The spherical image can also be projected to the six faces of a cube as an alternative 360-degree format. The conversion can be performed by projection conversion to derive the six-face images representing the six faces of a cube. On the faces of the cube, these six images are connected at the edges of the cube. In FIG. 1, image 100 corresponds to an unfolded cubic image with blank areas filled by dummy data. The unfolded cubic frame which is also referred as a cubic net with blank areas. As shown in FIG. 1, the unfolded cubic-face images with blank areas are fitted into a smallest rectangular that covers the six unfolded cubic-face images.

These six cube faces are interconnected in a certain fashion as shown in FIG. 1 since these six cubic faces correspond to six pictures on the six surfaces of a cubic. Accordingly, each edge on the cube is shared by two cubic faces. In other words, each four faces in the x, y and z directions are continuous circularly in a respective direction. The circular edges for the cubic-face assembled frame with blank areas (i.e. image 100 in FIG. 1) are illustrated by image 200 in FIG. 2. The cubic edges associated with the cubic face boundaries are labelled. The cubic face boundaries with the same edge number indicate that the two cubic face boundaries are connected and share the same cubic edge. For example, edge #2 is on the top of face 1 and on the right side of face 5. Therefore, the top of face 1 is connected to the right side of face 5. Accordingly, the contents on the top of face 1 flow continuously into the right side of face 5 when face 1 is rotated 90 degrees counterclockwise.

In the present invention, techniques for coding and signaling multiple face sequences are disclosed.

### BRIEF SUMMARY OF THE INVENTION

A method and apparatus of video encoding or decoding for a video encoding or decoding system applied to multi-face sequences corresponding to a 360-degree virtual reality sequence are disclosed. According to embodiments of the present invention, at least one face sequence of the multi-face sequences is encoded or decoded using face-independent coding, where the face-independent coding encodes or decodes a target face sequence using prediction reference data derived from previous coded data of the target face sequence only. Furthermore, one or more syntax elements can be signaled in a video bitstream at an encoder side or parsed from the video bitstream at a decoder side, where the syntax elements indicate first information associated with a total number of faces in the multi-face sequences, second information associated with a face index for each face-independent coded face sequence, or both the first information and the second information. The syntax elements can be located at a sequence level, video level, face level, VPS (video parameter set), SPS (sequence parameter set), or APS (application parameter set) of the video bitstream.

In one embodiment, all of the multi-face sequences are coded using the face-independent coding. A visual reference frame comprising of all faces of the multi-face sequences at a given time index can be used for Inter prediction, Intra prediction or both by one or more face sequences. In another embodiment, one or more Intra-face sets can be coded as random access points (RAPs), where each Intra-face set consists of all faces with a same time index and each random access point is coded using Intra prediction or using Inter prediction only based on one or more specific pictures. When a target specific picture is used for the Inter prediction, all faces in the target specific picture are decoded before the target specific picture is used for the Inter prediction. For any target face with a time index immediately after a random access point (RAP), if the target face is coded using temporal reference data, the temporal reference data exclude any non-RAP reference data.

In one embodiment, one or more first face sequences are coded using prediction data comprising at least a portion derived from a second face sequence. The one or more target first faces in said one or more first face sequences respectively use Intra prediction derived from a target second face in the second face sequence, where said one or more target first faces in said one or more first face sequences and the target second face in the second face sequence all have a same time index. In this case, for a current first block at a face boundary of one target first face, the target second face corresponds to a neighboring face adjacent to the face boundary of one target first face.

In another embodiment, one or more target first faces in said one or more first face sequences respectively use Inter prediction derived from a target second face in the second face sequence, where said one or more target first faces in said one or more first face sequences and the target second face in the second face sequence all have a same time index. For a current first block in one target first face in one target first face sequence with a current motion vector (MV) pointing to a reference block across a face boundary of one reference first face in said one target first face sequence, the target second face corresponds a neighboring face adjacent to the face boundary of one reference first face.

In yet another embodiment, one or more target first faces in said one or more first face sequences respectively use Inter prediction derived from a target second face in the second face sequence, where the target second face in the second face sequence has a smaller time index than any target first face in said one or more first face sequences. For a current first block in one target first face in one target first face sequence with a current motion vector (MV) pointing to a reference block across a face boundary of one reference first face in said one target first face sequence, the target second face corresponds a neighboring face adjacent to the face boundary of one reference first face.

### BRIEF DESCRIPTION OF THE DRAWINGS

FIG. 1 illustrates an example of an unfolded cubic frame corresponding to a cubic net with blank areas filled by dummy data.

FIG. 2 illustrates an example of the circular edges for the cubic-face assembled frame with blank areas in FIG. 1.

FIG. 3 illustrates an example of a fully face independent coding structure for VR video, where each cubic face sequence is treated as one input video sequence by a video encoder.

FIG. 4 illustrates an example of face independent coding with a random access point (k+n), where the set of faces at time k is a specific picture.

FIG. 5 illustrates an example of face sequence coding allowing prediction from other faces according to an embodiment of the present invention.

FIG. 6 illustrates an example of Intra prediction using information from another face having a same time index as the current face.

FIG. 7 illustrates an example of Inter prediction using information from another face having the same time index.

FIG. 8 illustrates another example of face sequence coding allowing prediction from other faces at the same time index according to an embodiment of the present invention.

FIG. 9 illustrates yet another example of face sequence coding allowing prediction from other faces at the same time index according to an embodiment of the present invention.

FIG. 10 illustrates an example of face sequence coding allowing temporal reference data from other faces according to an embodiment of the present invention.

FIG. 11 illustrates another example of face sequence coding allowing temporal reference data from other faces according to an embodiment of the present invention.

FIG. 12 illustrates an example of Inter prediction also using reference data from another face, where a current block in a current picture (time index k+2) in face 0 is Inter predicted also using reference data corresponding to prior pictures (i.e., time index k+1) in face 0 and face 4.

FIG. 13 illustrates an exemplary flowchart of video coding for multiple face sequences corresponding to 360-degree virtual reality sequence according to an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

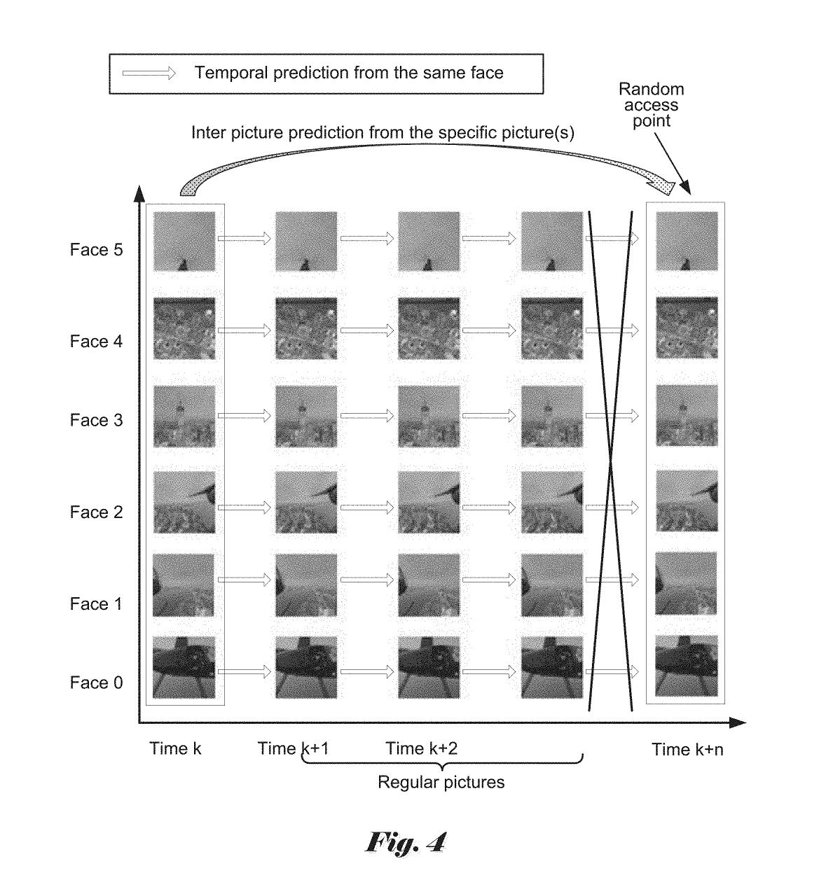

In the present invention, techniques for coding and signaling individual faces sequences are disclosed. FIG. 3 illustrates a fully face independent coding structure for VR video, where each cubic face sequence is treated as one input video sequence by a video encoder. At the decoder side, a video bitstream for a face sequence is received and decoded by the decoder. For cubic faces shown in FIG. 3, the six face sequences are treated as six video sequences and are coded independently. In other words, each face sequence is coded only using prediction data (Inter or Intra) derived from the same face sequence according to this embodiment. In FIG. 3, the faces having a same time index (e.g. k, k+1, k+2, etc.) are referred as an Intra-face set in this disclosure.

In FIG. 3, while the six faces associated with a cube are used as an example of multi-face VR video representation, the present invention may also applied to other multi-face representations. Another aspect of the present invention addresses signaling of the independently coded faces. For example, one or more syntax elements can be signal in the video bitstream to specify information related to the total number of faces in the multi-face sequences. Furthermore, information related to the face index for each independently coded face can be signaled. The one or more syntax elements can be signaled in the sequence level, video level, face level, VPS (video parameter set), SPS (sequence parameter set), or APS (application parameter set).

A visual reference frame is used for prediction in order to improve coding performance. The visual reference frame consists of at least two faces associated with one time index that can be used for motion compensation and/or Intra prediction. Therefore, the visual reference frame can be used to generate reference data for each face by using other faces in the visual reference frame for reference data outside a current face. For example, if face 0 is the current face, the reference data outside face 0 will likely be found in neighboring faces such as faces 1, 2 4 and 5. Similarly, the visual reference frame can also provide reference data for other faces when the reference data is outside a selected face.

The present invention also introduces face independent coding with a random access point. The random access point can be an Intra picture or Inter picture predicted from a specific picture or specific pictures, which can be other random access points. For a random access point frame, all the faces in the specific picture shall be decoded. Other regular picture can be selected and independently coded. The pictures after the random access point cannot be predicted from the regular pictures (i.e., non-specific pictures) coded before the random access point. If the visual reference frame as disclosed above is also applied, the visual reference picture may not be completed if only part of the regular pictures is decoded. Otherwise, this will cause prediction error. However, the error propagation will be terminated at the random access point.

FIG. 4 illustrates an example of face independent coding with a random access point (k+n). The set of faces at time k is a specific picture. The sets of faces (i.e., k+1, k+2, etc.) after the specific picture at time k are coded as regular pictures using temporal prediction from the same faces until a random access point is coded. As shown in FIG. 4, the temporal prediction chain is termination right before the random access point at time k+n. The random access point at time k+n can be either Intra coded or can be Inter coded only using specific picture(s) as reference picture(s).

While the fully face independent coding as shown in FIG. 3 and FIG. 4 provides more robust coding to eliminate the coding dependency between different face sequences. However, the fully face independent coding does not utilize the correlation among faces, in particular the continuity across face boundaries between two neighboring faces. In order to improve the coding efficiency, the prediction is allowed to use reference data from other faces according to another method of the present invention. For example, the Intra prediction for a current face may use reference data from other faces in the same time index. Also, for Inter prediction, if the motion vector (MV) points to the reference pixels outside the current reference face boundary, the reference pixels for Inter prediction can be derived from the neighboring faces of the current face having the same time index.

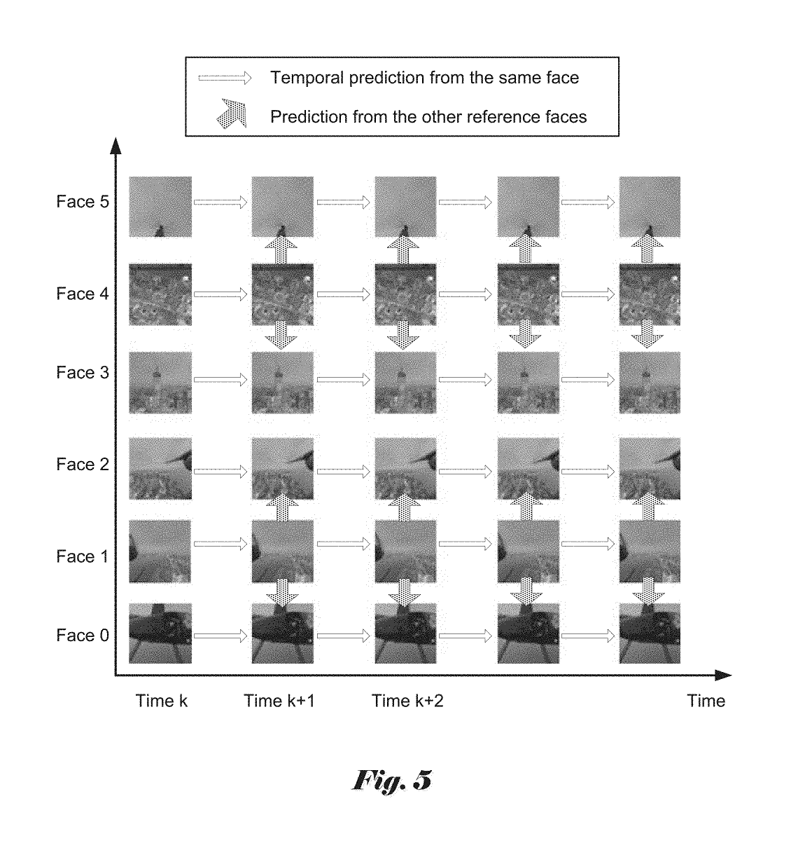

FIG. 5 illustrates an example of face sequence coding allowing prediction from other faces according to another method of the present invention. In the example of FIG. 5, face 5 and face 3 both use information from face 4 to derive prediction data. Also, face 2 and face 0 both use information from face 1 to derive prediction data. The example of FIG. 5 corresponds to the case of prediction using information from another face at the same time index. For face 4 and face 1, the face sequences are face independently coded without using reference data from other faces.

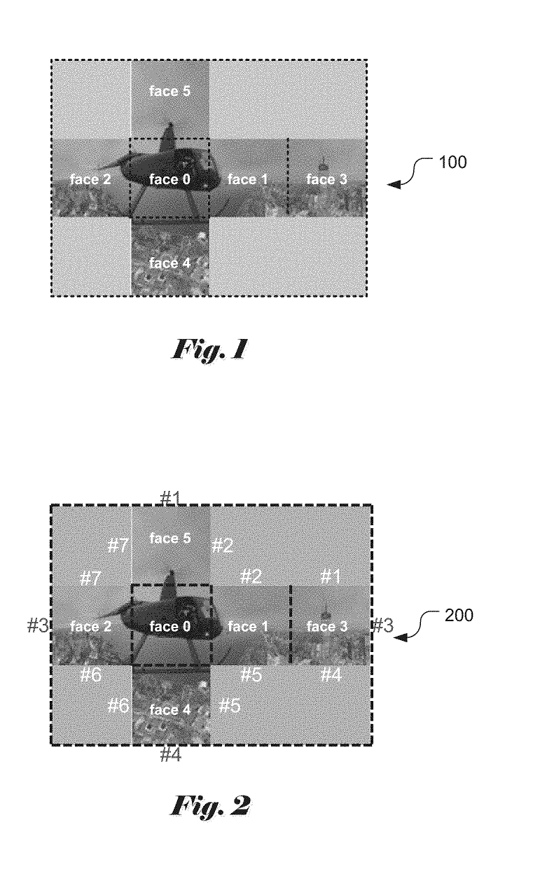

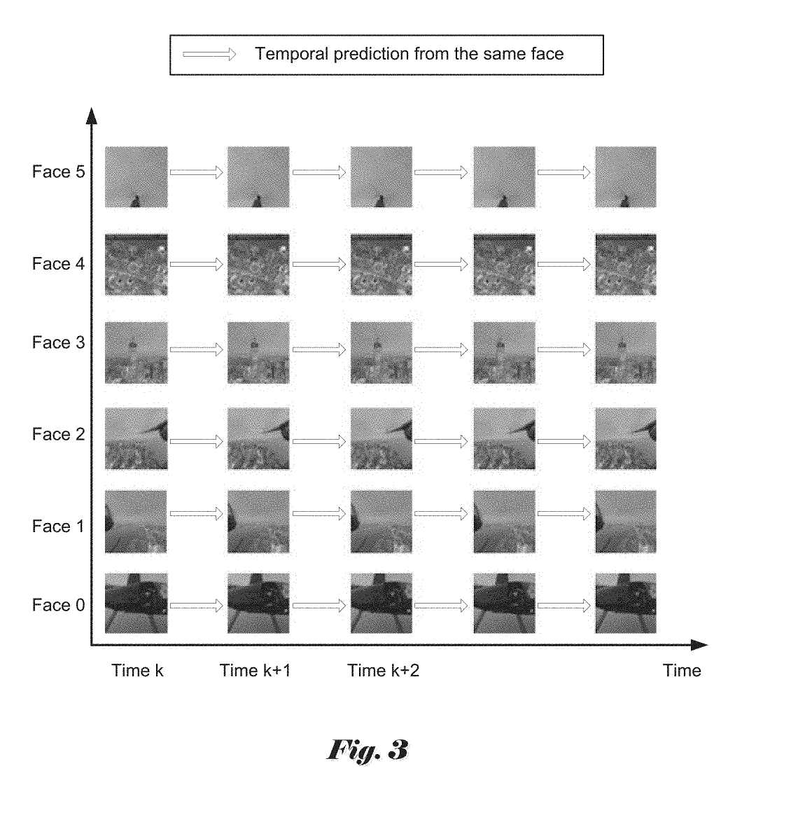

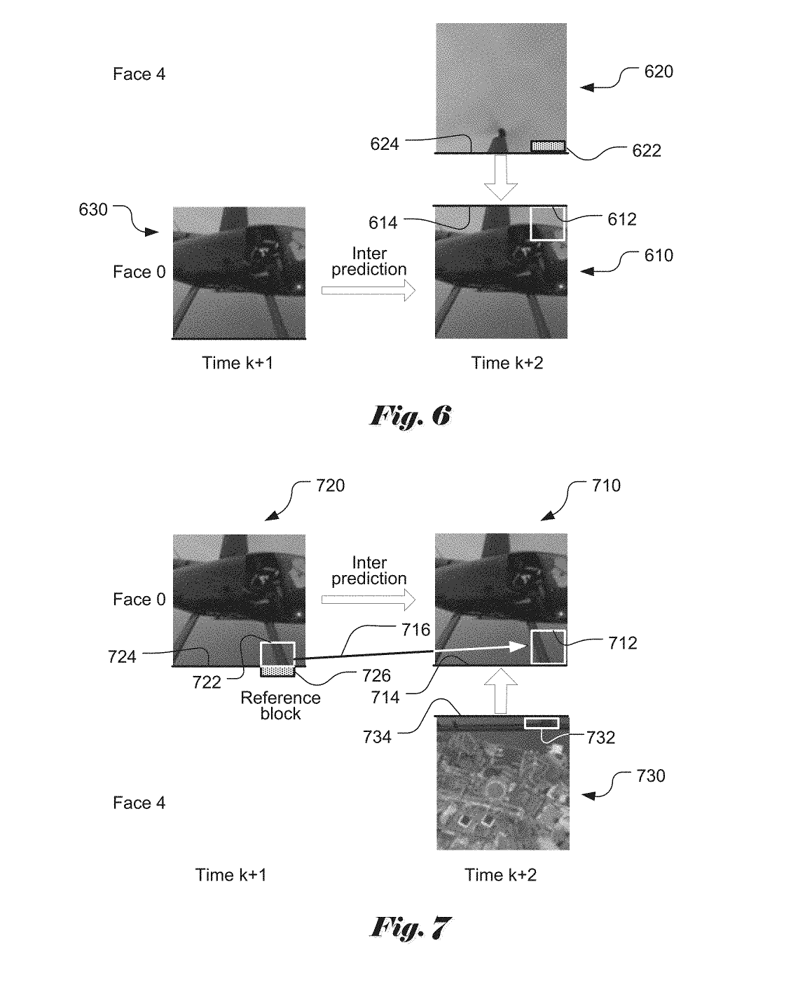

FIG. 6 illustrates an example of Intra prediction using information from another face having the same time index as the current face to derive the reference data. As shown in FIG. 1 and FIG. 2, the bottom face boundary of face 5 is connected to the top boundary of face 0. Therefore, Intra coding of a current block 612 in current face-0 picture 610 with time index k+2 near the top face boundary 614 may use the Intra prediction reference data 622 at the bottom face boundary 624 of face-5 picture 620 with time index k+2. In this case, it is assumed that the pixel data at the bottom face boundary 624 of face-5 picture 620 are coded prior to the current block 612 at the top boundary of face-0 picture 610. When current face-0 picture 610 with time index k+2 is Inter coded, it may use a face-0 picture 630 with time index k+1 to derive the Inter prediction data.

FIG. 7 illustrates an example of Inter prediction using information from another face having the same time index. In this example, a current face-0 picture is being coded using Inter prediction derived from previously coded data in the same face sequence. However, when the motion vector points to reference pixels outside the reference face in the same face sequence, reference data from another face having the same time index can be used to derive the needed reference data. In the example of FIG. 7, the current block 712 at the bottom face boundary 714 of the current face-0 picture 710 is Inter coded and the motion vector (MV) 716 points to reference block 722, where partial reference block 726 of the reference block 722 is located outside the bottom face boundary 724 of a face-0 reference picture 720. The reference area 726 located outside the bottom face boundary 724 of face-0 reference picture 720 corresponds to the pixels at the top face boundary 734 of face 4 since the top face boundary of face 4 shares a same edge as the bottom face boundary of face 0. According to an embodiment of the present invention, the corresponding reference pixels 732 of face-4 picture having the same time index are used to derive the Inter-prediction reference pixels (726) outside the bottom face boundary 724 of face-0 reference picture 720. It is noted that reference data from face 4 at the same time index as the current face-0 picture are used to derive the Inter-prediction reference data outside the current reference face 720.

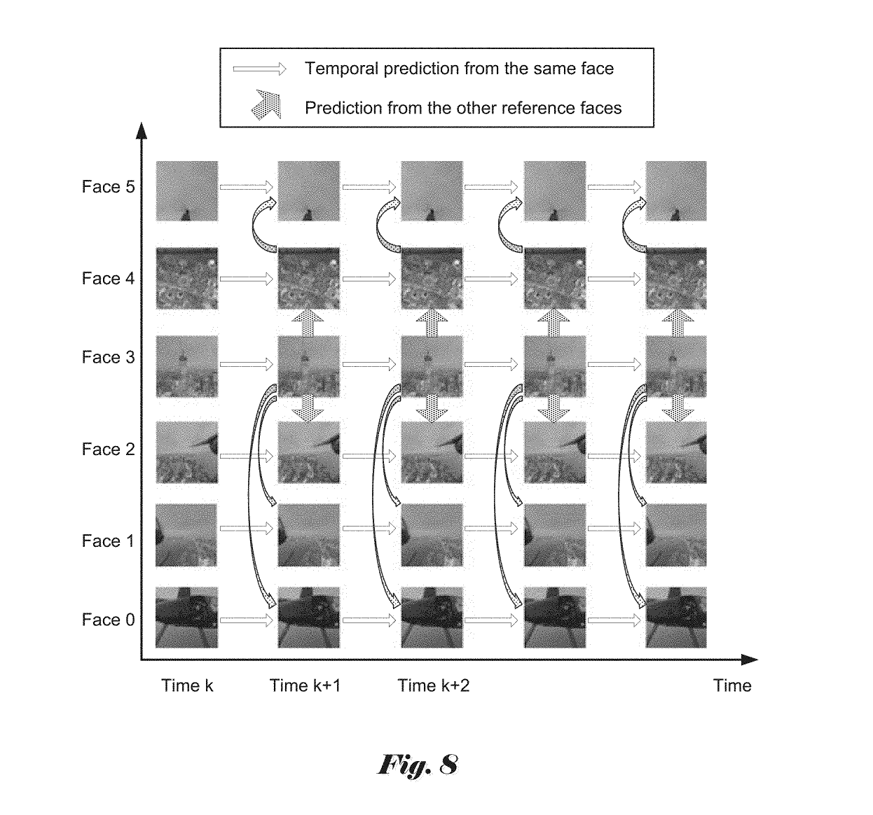

FIG. 8 illustrates another example of face sequence coding allowing prediction from other faces having the same time index according to an embodiment of the present invention. In this example, faces 0, 1, 2 and 4 use reference data from face 3 having the same time index. Furthermore, face 5 uses reference data from face 4 having the same time index. For face 3, the face sequence is face independently coded without using reference data from other faces.

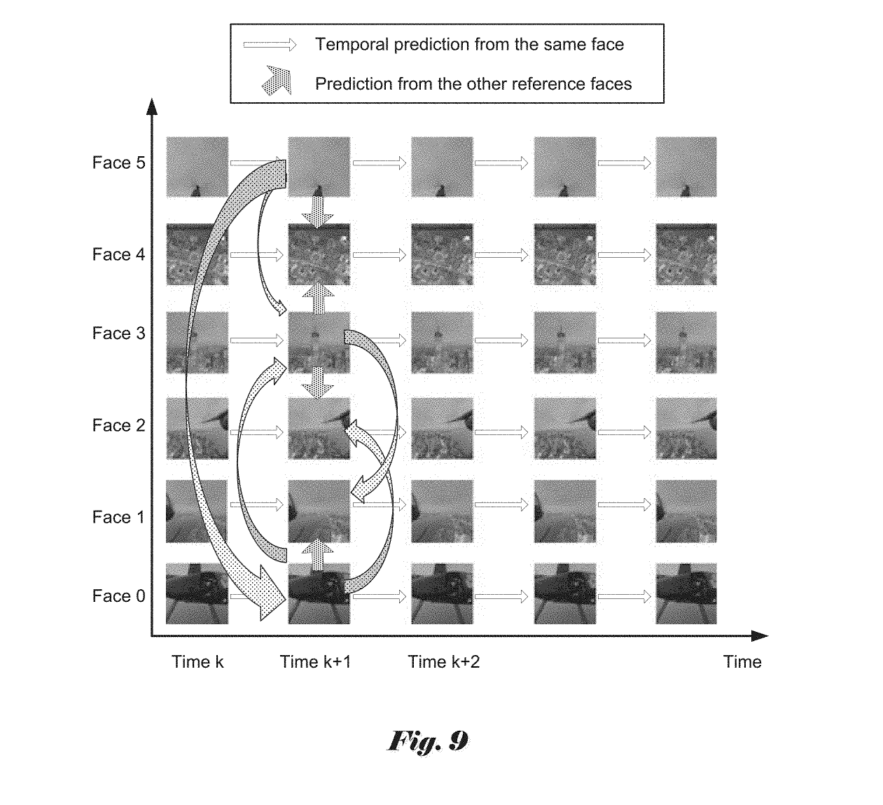

FIG. 9 illustrates yet another example of face sequence coding allowing prediction from other faces at the same time index according to an embodiment of the present invention. In this example, faces 1, 2 and 4 use reference data derived from face 3 having the same time index. Faces 0, 3 and 4 use reference data derived from face 5 having the same time index. Faces 1, 2 and 3 use reference data derived from face 0 having the same time index. For face 5, the face sequence is face independently coded without using reference data from other faces. In FIG. 9, the Intra face dependency is only shown for time k+1 in order to simplify the illustration. However, the same Intra face dependency is also applied to other time indices.

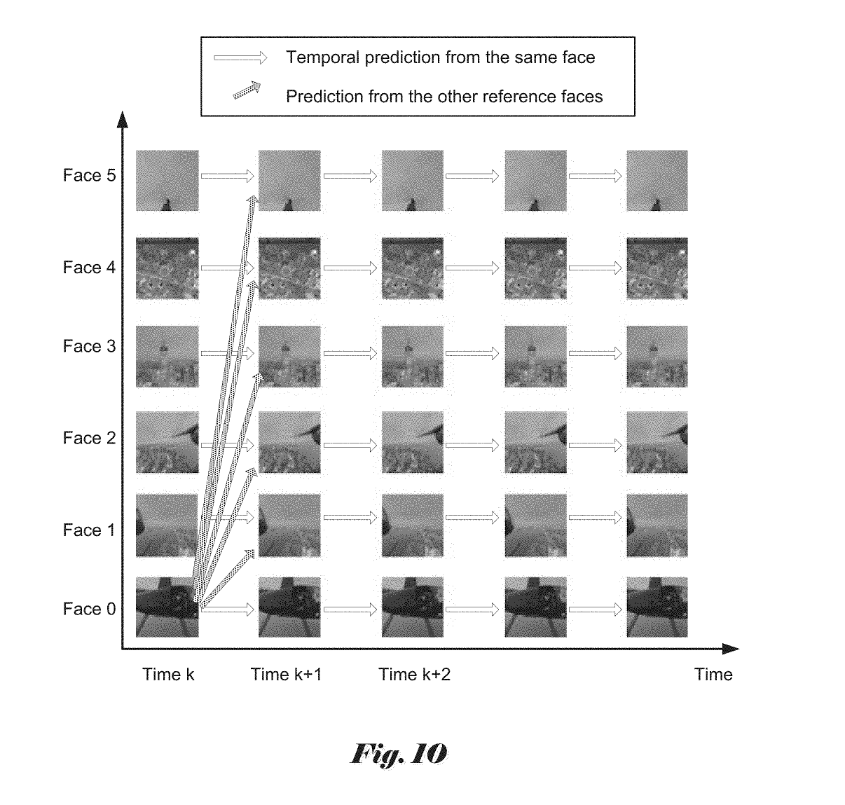

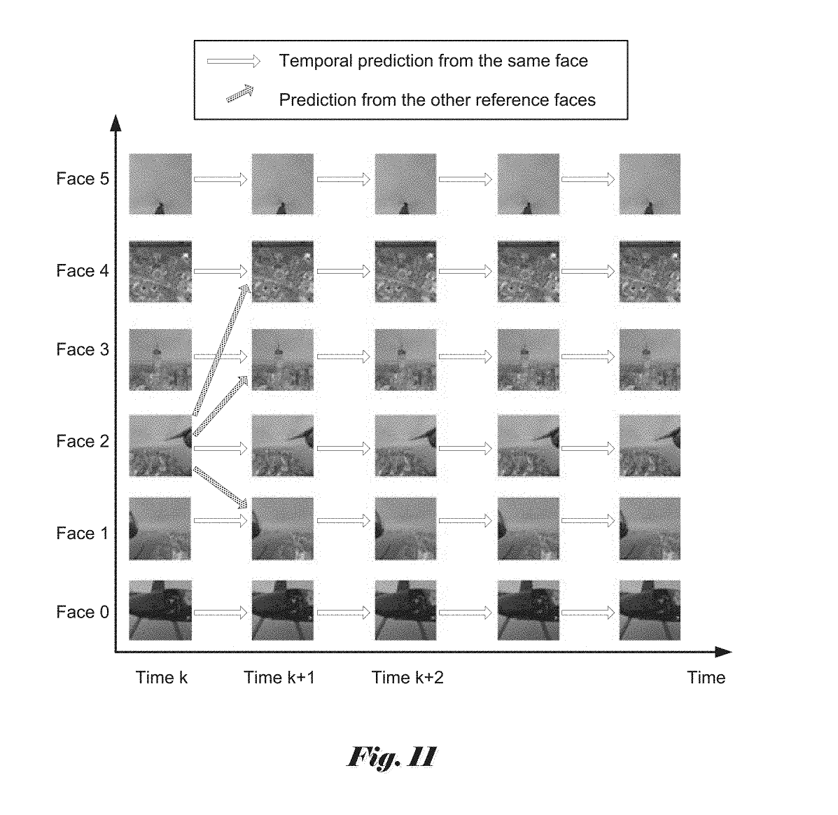

In the previous examples, the prediction between faces uses other faces having the same time unit. According to another method of the present invention, the prediction between faces may also use the temporal reference data from other faces. FIG. 10 illustrates an example of face sequence coding allowing temporal reference data from other faces according to an embodiment of the present invention. In other words, other faces are used to derive the Inter prediction for a current block in a current face, wherein other faces used to derive the reference data have a time index smaller than the time index of the current face. For example, face 0 at time k can be used to derive Inter prediction for faces 1 through 5 at time index k+1. For face 0, the face sequence is face independently coded without using reference data from other faces.

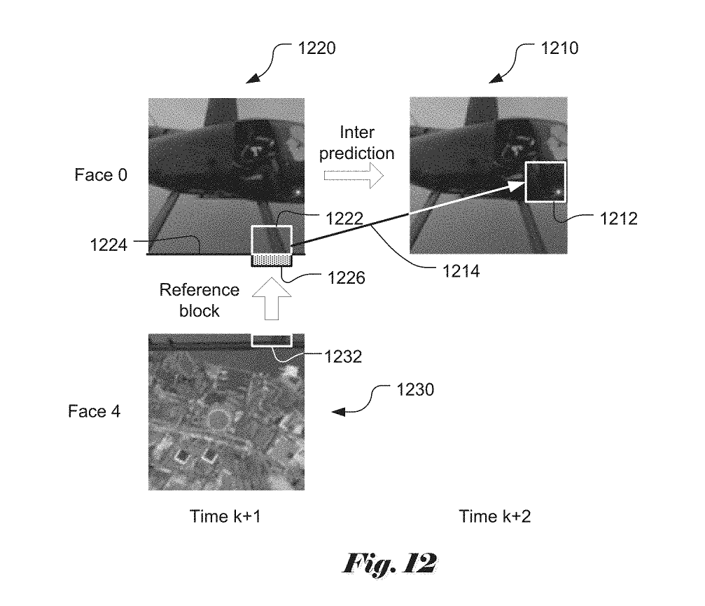

FIG. 11 illustrates another example of face sequence coding allowing temporal reference data from other faces according to an embodiment of the present invention. In this example, face 2 having time k is used to derive Inter prediction data for faces 1, 3 and 4 having time index k+1. For faces 0, 2 and 5, the face sequences are face independently coded without using reference data from other faces.

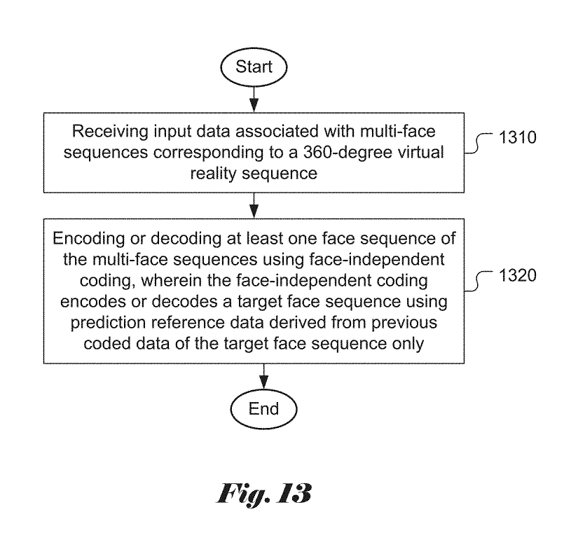

FIG. 12 illustrates an example of Inter prediction using reference data from another face. In this example, current block 1212 in a current picture 1200 having time index k+2 in face 0 is Inter predicted using reference data in a prior picture 1220 having time index k+1 in face 0. The motion vector 1214 points to reference block 1222 that is partially outside the face boundary (i.e., below the face boundary 1224). The area 1226 outside the face boundary 1224 of face 0 corresponds to area 1232 on the top side of face-4 picture 1230 with time index k+1. According to an embodiment of the present invention, face-4 picture having time index k+1 is used to derive reference data corresponding to area 1226 outside the face boundary of face 0.

The inventions disclosed above can be incorporated into various video encoding or decoding systems in various forms. For example, the inventions can be implemented using hardware-based approaches, such as dedicated integrated circuits (IC), field programmable logic array (FPGA), digital signal processor (DSP), central processing unit (CPU), etc. The inventions can also be implemented using software codes or firmware codes executable on a computer, laptop or mobile device such as smart phones. Furthermore, the software codes or firmware codes can be executable on a mixed-type platform such as a CPU with dedicated processors (e.g. video coding engine or co-processor).

FIG. 13 illustrates an exemplary flowchart of video coding for multiple face sequences corresponding to 360-degree virtual reality sequence according to an embodiment of the present invention. According to this method, input data associated with multi-face sequences corresponding to a 360-degree virtual reality sequence are received in step 1310. In the encoder side, the input data correspond to pixel data of the multi-face sequences to be encoded. At the decoder side, the input data correspond to a video bitstream or coded data that are to be decoded. In step 1320, at least one face sequence of the multi-face sequences is encoded or decoded using face-independent coding, where the face-independent coding encodes or decodes a target face sequence using prediction reference data derived from previous coded data of the target face sequence only.

The above flowcharts may correspond to software program codes to be executed on a computer, a mobile device, a digital signal processor or a programmable device for the disclosed invention. The program codes may be written in various programming languages such as C++. The flowchart may also correspond to hardware based implementation, where one or more electronic circuits (e.g. ASIC (application specific integrated circuits) and FPGA (field programmable gate array)) or processors (e.g. DSP (digital signal processor)).

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method for video encoding or decoding for a video encoding or decoding system applied to multi-face sequences corresponding to a 360-degree virtual reality sequence, the method comprising:
receiving input data associated with multi-face sequences corresponding to a 360-degree virtual reality sequence; and
encoding or decoding at least one face sequence of the multi-face sequences using face-independent coding, wherein the face-independent coding encodes or decodes a target face sequence using prediction reference data derived from previous coded data of the target face sequence only.

2. The method of claim 1, wherein one or more syntax elements are signaled in a video bitstream at an encoder side or parsed from the video bitstream at a decoder side, wherein said one or more syntax elements indicate first information associated with a total number of faces in the multi-face sequences, second information associated with a face index for each face-independent coded face sequence, or both the first information and the second information.

3. The method of claim 2, wherein said one or more syntax elements are located at a sequence level, video level, face level, VPS (video parameter set), SPS (sequence parameter set), or APS (application parameter set) of the video bitstream.

4. The method of claim 1, wherein all of the multi-face sequences are coded using the face-independent coding.

5. The method of claim 1, wherein one visual reference frame comprising of at least two faces of the multi-face sequences at a given time index is used for Inter prediction, Intra prediction or both by one or more face sequences.

6. The method of claim 1, wherein one or more Intra-face sets are coded as random access points (RAPs), wherein each Intra-face set consists of all faces with a same time index and each random access point is coded using Intra prediction or using Inter prediction only based on one or more specific pictures.

7. The method of claim 6, wherein when a target specific picture is used for the Inter prediction, all faces in the target specific picture are decoded before the target specific picture is used for the Inter prediction.

8. The method of claim 6, wherein for any target face with a time index after a random access point (RAP), if the target face is coded using temporal reference data, the temporal reference data exclude any non-RAP reference data coded before the random access point.

9. The method of claim 1, wherein one or more first face sequences are coded using prediction data comprising at least a portion derived from a second face sequence.

10. The method of claim 9, wherein one or more target first faces in said one or more first face sequences respectively use Intra prediction derived from a target second face in the second face sequence, wherein said one or more target first faces in said one or more first face sequences and the target second face in the second face sequence all have a same time index.

11. The method of claim 10, wherein for a current first block at a face boundary of one target first face, the target second face corresponds a neighboring face adjacent to the face boundary of one target first face.

12. The method of claim 9, wherein one or more target first faces in said one or more first face sequences respectively use Inter prediction derived from a target second face in the second face sequence, wherein said one or more target first faces in said one or more first face sequences and the target second face in the second face sequence all have a same time index.

13. The method of claim 12, wherein for a current first block in one target first face in one target first face sequence with a current motion vector (MV) pointing to a reference block across a face boundary of one reference first face in said one target first face sequence, the target second face corresponds a neighboring face adjacent to the face boundary of one reference first face.

14. The method of claim 9, wherein one or more target first faces in said one or more first face sequences respectively use Inter prediction derived from a target second face in the second face sequence, wherein the target second face in the second face sequence has a smaller time index than any target first face in said one or more first face sequences.

15. The method of claim 14, wherein for a current first block in one target first face in one target first face sequence with a current motion vector (MV) pointing to a reference block across a face boundary of one reference first face in said one target first face sequence, the target second face corresponds a neighboring face adjacent to the face boundary of one reference first face.

16. An apparatus for video encoding or decoding for a video encoding or decoding system applied to multi-face sequences corresponding to 360-degree virtual reality sequence, the apparatus comprising one or more electronics or processors arranged to:
receive input data associated with multi-face sequences corresponding to a 360-degree virtual reality sequence; and
encode or decode at least one face sequence of the multi-face sequences using face-independent coding, wherein the face-independent coding encodes or decodes a target face sequence using prediction reference data derived from previous coded data of the target face sequence only.
